(19) United States
(12) Patent Application Publication
(10) Pub. No.: US 2011/0002009 A1
(43) Pub. Date: Jan. 6, 2011

(54) PRINTER SELECTION SYSTEM

(75) Inventor: Tsuyoshi Ohashi, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA, Nagoya-shi (JP)

(21) Appl. No.: 12/882,360

(22) Filed: Sep. 15, 2010

Related U.S. Application Data
(63) Continuation-in-part of application No. PCT/JP2009/052655, filed on Feb. 17, 2009.

(30) Foreign Application Priority Data
Mar. 29, 2008 (JP) 2008-088942

(51) Int. Cl. G06F 15/00; G06F 3/12; H04B 7/00

(52) U.S. Cl. 358/1.15; 455/41.2

(57) ABSTRACT

A printer selection system to select a printer for performing output from a plurality of printers includes: a mobile station moved along with a computer; a plurality of base stations fixedly disposed at known positions; and a server connected to the computer that enables data communication, the server including a positioning portion that determines a position of the computer based on a reception result of a radio wave for position detection transmitted from one of the base stations and the mobile station and received by the other, a printer position database portion storing information about positions of the printers, a distance determining portion that determines a distance between each of the printers and the computer, and a printer setting portion that sets a printer having the shortest distance as a printer that performs the output from the computer based on the distances between each of the printers and the computer.

### CROSS REFERENCE TO RELATED APPLICATION

The present application is a Continuation-in-Part of International Application No. PCT/JP2009/052655 filed Feb. 17, 2009, which claims the benefits of Japanese Patent Application No. 2008-088942 filed Mar. 29, 2008, the disclosure of which is herein incorporated by reference in its entirety.

### BACKGROUND OF THE DISCLOSURE

1. Technical Field

The present invention relates to a printer selection system, and, more particularly, to a system selecting a printer by detecting a position of a computer for output from the printer located at the shortest distance from the computer if a plurality of printers is usable.

2. Background Art

Recently, an environment equipped with a plurality of printers has generally been formed in an office. The printers are connectable to a network due to inclusion of network interfaces, etc. Therefore, computers connected to the same network are able to output to the printers through the network.

In this case, it is desirable in an office environment equipped with a plurality of printers to perform output from a printer located nearest to an outputting computer.

A related art discloses a technique of calculating a degree of optimum arrangement of a multi-function peripheral based on usage history, etc., collected from the multi-function peripheral capable of executing a plurality of functions. With the technique disclosed in the related art, the optimum arrangement location can be analyzed with consideration given to operation frequencies of the functions of the multi-function peripheral.

However, the technique of the related art relates to a technique of determining an arrangement location rather than a technique of selecting one from a plurality of printers having arrangement locations determined in advance.

### SUMMARY OF THE DISCLOSURE

In the office environment equipped with a plurality of printers as described above, printers are conventionally set in advance that enable output from a computer requesting the output. A user of the computer selects a printer for the output among the printers set in advance.

A user of the computer must select the printer nearest to the computer by himself/herself to make an output request to the printer. Therefore, if a portable computer is used while moving, a printer must be selected again each time output to a printer is made. However, for example, since a location of a printer is not known at the destination of movement, it is difficult to select a printer.

It is therefore the object of the present invention to provide a printer selection system that selects, in response to an output request from a computer, a printer that performs the output among a plurality of printers.

A first aspect of the present invention provides (a) a printer selection system that responds to an output request from a computer to select a printer for performing output responsive to the output request from a plurality of printers connected through a communication network to the computer, comprising: (b) a mobile station moved along with the computer; (c) a plurality of base stations fixedly disposed at known positions; and (d) a server connected to the computer in a manner that enables data communication, (e) the server including a positioning portion that determines a position of the mobile station as a position of the computer based on a reception result of a radio wave for position detection transmitted from one of the plurality of the base stations and the mobile station and received by the other, (f) a printer position database portion storing information about positions of the plurality of the printers stored therein in advance, (g) a distance determining portion that determines a distance between a position of each of the plurality of the printers and the position of the computer, and (h) a printer setting portion that sets a printer having the shortest distance as a printer that performs the output from the computer based on the distances between the position of each of the plurality of the printers and the position of the computer that are determined by the distance determining portion.

### BRIEF DESCRIPTION OF DRAWINGS

FIG. 1 is a diagram for explaining an exemplary configuration of a printer selection system of the present invention.

FIG. 2 is a diagram for explaining exemplary functions of a mobile station making up the printer selection system of FIG. 1.

FIG. 3 is a diagram for explaining exemplary functions of a base station making up the printer selection system of FIG. 1.

FIG. 4 is a diagram for explaining an exemplary configuration of a server making up the printer selection system of FIG. 1.

FIG. 5 is a diagram for explaining exemplary functions of a positioning server making up the printer selection system of FIG. 1.

FIG. 6 is a diagram for explaining a principle of a positioning operation of a positioning portion.

FIG. 7 is a diagram for explaining exemplary functions of an application server making up the printer selection system of FIG. 1.

FIG. 8 is a diagram for explaining an example of information stored in a printer position database portion in the application server of FIG. 7.

FIG. 9 is a diagram for explaining an example of a distance calculation operation by a computer-printer distance calculating portion in the application server of FIG. 7.

FIG. 10 is a diagram for explaining an example of information about a distance between a computer and each of a plurality of printers calculated by the computer-printer distance calculating portion in the application server of FIG. 7.

FIG. 11 is a diagram for explaining an example of information stored in a printer attribution database portion in the application server of FIG. 7.

FIG. 12 is a diagram for explaining an example of display generated by a display control portion 64 in the application server of FIG. 7 and displayed on a displaying device of a computer of FIG. 1.

FIG. 13 is a diagram for explaining an exemplary configuration of a computer making up the printer selection system of FIG. 1.

FIG. 14 is a diagram for explaining exemplary functions of the computer of FIG. 13.

FIG. 15 is a diagram for explaining an exemplary configuration and functions of a printer making up the printer selection system of FIG. 1.

FIG. 16 is a flowchart for generally explaining a control operation for a printer selection operation in the printer selection system of FIG. 1.

FIG. 17 is a flowchart for explaining a mobile station positioning routine of FIG. 16.

FIG. 18 is a flowchart for explaining an output destination printer selection routine of FIG. 16.

FIG. 19 is a diagram for explaining an example of information stored in a passageway information database portion in the application server of FIG. 7.

FIG. 20 is a diagram for explaining an example of a distance calculation operation by the computer-printer distance calculating portion in the application server of FIG. 7 in another embodiment of the present invention.

FIG. 21 is a diagram for explaining an example of display generated by the display control portion 64 in the application server of FIG. 7 and displayed on the displaying device of the computer of FIG. 1 in another embodiment of the present invention.

FIG. 22 is a diagram for explaining an example of display generated by the display control portion 64 in the application server of FIG. 7 and displayed on the displaying device of the computer of FIG. 1 in further embodiment of the present invention.

FIG. 23 is a diagram for explaining an exemplary configuration in another embodiment of the printer selection system of the present invention, corresponding to FIG. 1.

FIG. 24 is a diagram for explaining an exemplary configuration in further embodiment of the printer selection system of the present invention.

FIG. 25 is a diagram for explaining an exemplary configuration of a printer making up the printer selection system of FIG. 24, corresponding to FIG. 1.

FIG. 26 is a diagram for explaining an exemplary configuration of a computer making up the printer selection system of FIG. 24.

### DESCRIPTION OF THE EMBODIMENTS

An embodiment of the present invention will now be described in detail with reference to the drawings.

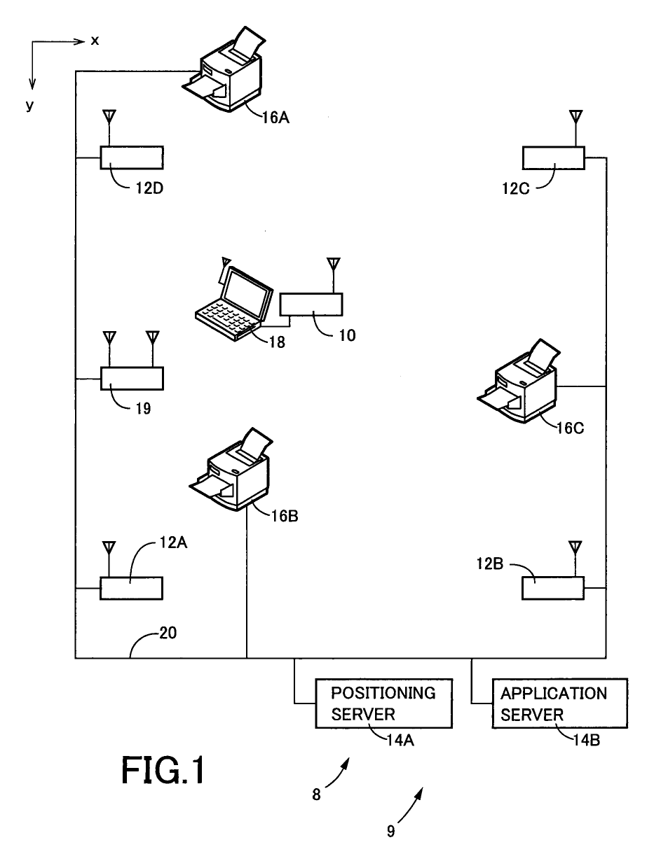

As depicted in FIG. 1, a printer selection system 9 is made up of a plurality of printers, i.e., a first printer 16A, a second printer 16B, a third printer 16C (hereinafter, printers 16 if no distinction is made between individual printers), a computer 18, a mobile station 10, a plurality of base stations, i.e., a first base station 12A, a second base station 12B, a third base station 12C, a fourth base station 12D (hereinafter, base stations 12 if no distinction is made between individual base stations), a positioning server 14A, an application server 14B, etc. The computer 18 performs output from one of a plurality of the printers 16. The mobile station 10 is moved along with the computer 18 and transmits radio waves for position detection. The base stations 12 are disposed at known positions to receive the radio waves transmitted from the mobile station 10. The positioning server 14A performs calculation of the position (positioning) of the mobile station 10 based on the reception results in a plurality of the base stations 12 of the radio waves transmitted by the mobile station 10 and received by a plurality of the base stations 12. In response to an output request from the computer 18, the application server 14B determines the printer 16 that performs the output. The printer selection system 9 of FIG. 1 includes a positioning system 8 including the mobile station 10, the base stations 12, and the positioning server 14A. As described later, the number of the necessary base stations 12 varies depending on the aspect of movement of the mobile station 10 and, for example, if the position is calculated for the mobile station 10 moving on a flat surface, the number of the base stations 12 may be at least three. The number of the mobile stations 10 is not particularly limited, provided that the number is one or more.

As depicted in FIG. 1, the printer 16, the base station 12, the positioning server 14A, and the application server 14B are connected to each other through, for example, a communication cable 20 in a manner that enables information communication. The computer 18 enables radio information communication with an access point 19 connected to the communication cable 20 and, therefore, the computer 18 enables the information communication with each of the printer 16, the base station 12, the positioning server 14A, and the application server 14B through the access point 19 and the communication cable 20.

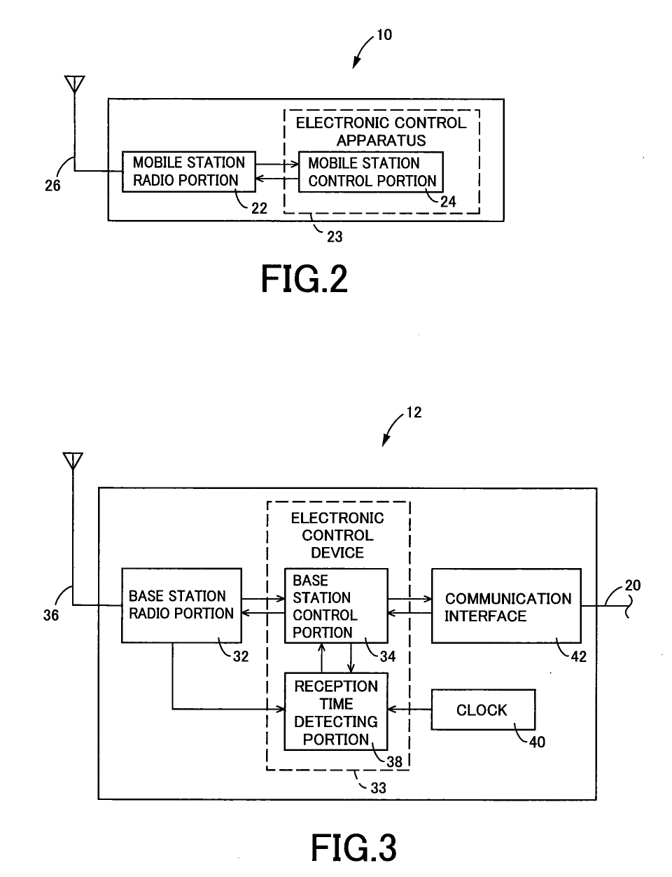

FIG. 2 is a block diagram for generally explaining functions of the mobile station 10. The mobile station 10 is made up of an antenna 26, a mobile station radio portion 22, an electronic control device 23, etc. The electronic control device 23 includes a so-called microcomputer equipped with CPU, RAM, ROM, and I/O interface, for example. The CPU executes a signal process in accordance with a program stored in the ROM in advance while utilizing a temporary storage function of the RAM to execute a process in a mobile station control portion 24 described later, etc.

The mobile station radio portion 22 implements a so-called radio communication function and uses the antenna 26 to transmit/receive radio waves. For example, the mobile station radio portion 22 transmits radio waves including a spread code for calculating a correlation value to the base station 12. The mobile station radio portion 22 receives radio waves transmitted from the base station 12 including a command for the operation of the mobile station 10. The mobile station radio portion 22 includes an oscillator that generates a carrier wave of a predetermined frequency and modulates the carrier wave based on a signal to be transmitted through radio waves. The mobile station radio portion 22 also includes a modulator that performs digital modulation, etc., and a transmission amplifier that amplifies the modulated carrier wave to a predetermined output power. The mobile station radio portion 22 also has a reception function implemented by a reception amplifier that amplifies a reception wave received by the antenna 26, a filter that takes out only a predetermined frequency component from the reception wave, and a demodulator that performs digital demodulation or demodulation by a wave detector. For example, since so-called digital communication is preferably used for the radio communication performed by the mobile station radio portion 22 in this case, the mobile station radio portion 22 includes a mechanism for modulation or demodulation necessary for the digital communication.

The antenna 26 is used when the mobile station radio portion 22 transmits/receives a radio wave and an antenna suitable for a frequency of a radio wave to be transmitted/received is employed. An antenna nondirectional at least in the propagation direction of the radio waves, for example, a Brown antenna or a perpendicularly disposed sleeve antenna is preferably used for the antenna 26 such that the base stations 12 at the same distances from the antenna 26 can receive the radio waves with the same intensity regardless of directions from the mobile station 10 if the distances from the mobile station 10 are the same.

The mobile station control portion 24 is implemented by the electronic control device 23 and controls the mobile station radio portion 22. Specifically, for example, the mobile station control portion 24 performs switch-over to transmission or reception, sets a carrier wave frequency, and sets the output power of the transmission amplifier for the mobile station radio portion 22. The setup values for these controls are determined as a result of communication with the base station 12, for example, based on a command transmitted from the base station 12. The mobile station control portion 24 analyzes a command for the control operation of the mobile station 10 from the base station 12 by analyzing the contents of the radio wave from the base station 12 received and decoded in the mobile station radio portion 22. The mobile station control portion 24 reads a stored spread code from a storage means not shown, for example, or generates a spread code based on a predetermined generating method, for example, a primitive polynomial defined in advance to determine the spread code transmitted through radio waves by the mobile station 10.

As depicted in FIG. 3, the base station 12 includes an antenna 36, a base station radio portion 32, an electronic control device 33, a clock 40, a communication interface 42, etc. The electronic control device 33 includes a so-called microcomputer equipped with CPU, RAM, ROM, and I/O interface, for example. The CPU executes a signal process in accordance with a program stored in the ROM in advance while utilizing a temporary storage function of the RAM to execute a process in a reception time detecting portion 38, a base station control portion 34, etc.

The base station radio portion 32 implements a so-called radio communication function and uses the antenna 36 to transmit/receive radio waves. The base station radio portion 32 transmits radio waves including a command for controlling the operation of the mobile station 10. The base station radio portion 32 receives radio waves transmitted by the mobile station 10 and delivers the contents thereof to the reception time detecting portion 38, which is described later, etc., to cause a process to be executed. Therefore, the base station radio portion 32 includes an oscillator that generates a carrier wave of a predetermined frequency, a modulator that modulates the carrier wave based on a signal to be transmitted through radio waves and that performs digital modulation, etc., and a transmission amplifier that amplifies the modulated carrier wave to a predetermined output power. The base station radio portion 32 is also implemented by a reception amplifier that amplifies a reception wave received by the antenna 36, a filter that takes out only a predetermined frequency component from the reception wave, and a demodulator that performs digital demodulation or demodulation by a wave detector. For example, since so-called digital communication is preferably used for the radio communication performed by the base station radio portion 32 in this case, the base station radio portion 32 includes a mechanism for modulation or demodulation necessary for the digital communication.

The antenna 36 is used when the base station radio portion 32 transmits/receives a radio wave and an antenna suitable for a frequency of the radio wave to be transmitted/received is employed. An antenna nondirectional at least in the propagation direction of the radio waves, for example, a Brown antenna or a perpendicularly disposed sleeve antenna is preferably used for the antenna 36 such that the radio waves can be received with the same intensity if the mobile station 10 exists at the same distances from the base stations 12 regardless of the position of the mobile station 10, i.e., the directions of the mobile station 10 from the viewpoints of the base stations 12.

The base station control portion 34 and the reception time detecting portion 38 are implemented by the electronic control device 33. The base station control portion 34 controls the base station radio portion 32. Specifically, for example, the base station control portion 34 performs switch-over to transmission or reception, sets the frequency of the carrier wave and sets the output power of the transmission amplifier for the base station radio portion 32 etc. The setup values for these controls are determined as a result of communication with the positioning server 14A described later or the mobile station 10. The base station control portion 34 controls the execution of detection of a reception time and controls the request and acquisition of output of a reception time detection result for the reception time detecting portion 38. The base station control portion 34 analyzes the contents of the radio wave transmitted by the mobile station 10 and received and decoded in the base station radio portion 32. In the same way, the base station control portion 34 analyzes the contents of the transmission from the positioning server 14A received by the communication interface 42 described later to take out a command related to the control operation of the base station 12. The base station control portion 34 transmits information necessary for another device through the communication interface 42 described later and the base station radio portion 32.

The reception time detecting portion 38 calculates a correlation value between the spread code included in the radio wave transmitted from the mobile station 10 and a replica code of the spread code. Specifically, the reception time detecting portion 38 acquires the replica code same as the spread code to be transmitted by the mobile station 10 in advance, and the replica code and the spread code (reception code) taken out from the received radio wave from the mobile station 10 are input to a matched filter to acquire the correlation value between both codes. A time indicative of the peak of the correlation value is defined as the reception time of the radio wave. Therefore, the reception time is detected by acquiring the time indicative of the peak of the correlation value from the clock 40 described later.

The clock 40 measures time and is used as a reference, for example, when the reception time detecting portion 38 detects the reception time. The base stations 12 have their respective clocks and the times thereof are synchronized in advance.

The communication interface 42 performs the information communication between another base station 12 connected through the communication cable 20, the positioning server 14A, etc. Specifically, the base station 12 transmits to the positioning server 14A the radio wave reception time detected by the reception time detecting portion 38 of the base station 12 and the information included in the radio wave transmitted from the mobile station 10 and receives a command related to the operation of the base station 12 transmitted from the positioning server 14A.

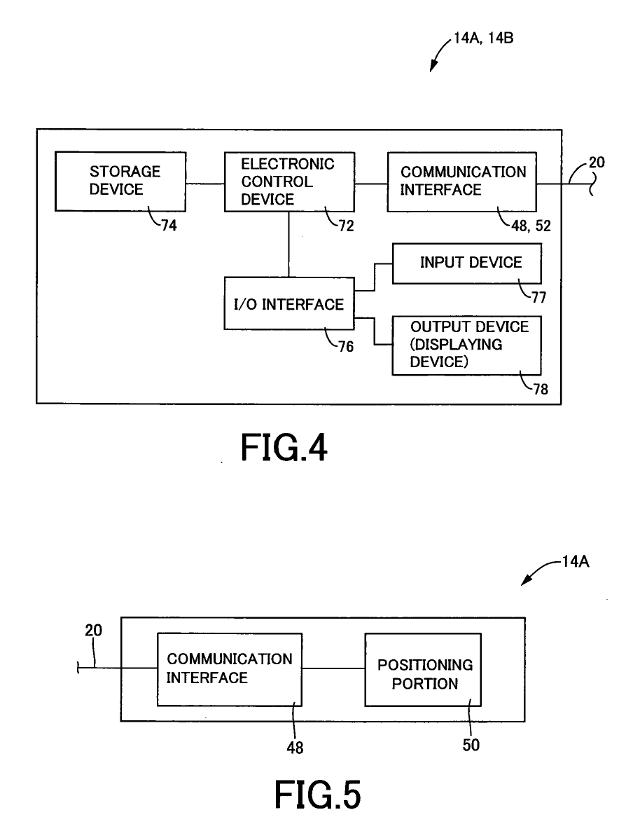

FIG. 4 is a schematic of configurations of the positioning server 14A and the application server 14B (hereinafter, servers 14 if no distinction is made between individual servers). As depicted in FIG. 4, the server 14 includes an electronic control device 72, a storage device 74, an I/O interface 76, an input device 77 and an output device 78 connected to the I/O interface 76, a communication interface 48, etc. Therefore, the server 14 includes a so-called computer. Specifically, the electronic control device 72 corresponds to CPU and executes necessary computing processes. The storage device 74 corresponds to RAM, ROM, or a hard disc and stores information in a readable manner in accordance with instructions from the electronic control device 72, etc. The input device 77 corresponds to a keyboard, a mouse, etc., that accept input operations to the servers 14 from a user. The output device 78 corresponds to a displaying device for displaying a result of operation by the servers 14. The CPU can execute a signal process in accordance with a program stored in the ROM in advance while utilizing a temporary storage function of the RAM.

The communication interface 48 performs the information communication with another base station 12, another server 14, or the printers 16 through the communication cable 20, for example. The communication interface 48 transmits a command related to the control operation of the base station 12 and information related to the position of the mobile station 10 calculated by a positioning portion 50 described later from the server 14 to the base station 12, for example, and receives information transmitted by the base station 12, for example, information related to the radio wave reception time at the base station 12. The radio wave reception time at the base station 12 is detected by the reception time detecting portion 38 as a reception time of the spread code transmitted from the mobile station 10.

The functions included in the electronic control device 72 of the positioning server 14A depicted in FIG. 5 are implemented, for example, by executing a predetermined program in the server 14 of FIG. 4. The positioning portion 50 calculates the position of the mobile station 10 based on time differences of the reception times of the radio wave from the mobile station 10 detected in the four base stations 12 (TDOA (Time Difference of Arrival) method). Assuming that the coordinates of the mobile station are (x,y), that the coordinates representative of the position of the first base station 12A are (x_{B1},y_{B1}), that the coordinates of the second base station 12B are (x_{B2},y_{B2}), that the coordinates of the third base station 12C are (x_{B3},y_{B3}), and that the coordinates of the fourth base station 12D are (x_{B4},y_{B4}), the position of the mobile station is represented by the following equations (1). In this case, the coordinates of the base stations 12 and the mobile station 10 are represented by the coordinate system defined as depicted in FIG. 1, for example.

(x_{B1}−x)²+(y_{B1}−y)²={c×(Tr₁−Tₛ)}²

(x_{B2}−x)²+(y_{B}−y)²={c×(Tr₂−Tₛ)}²

(x_{B3}−x)²+(y_{B3}−y)²={c×(Tr₃−Tₛ)}²

(x_{B4}−x)²+(y_{B4}−y)²={c×(Tr₄−Tₛ)}² (1)

Tr₁ to Tr₄ denote the radio wave reception times at the first base station 12A to the fourth base station 12D and Ts denotes the radio wave transmission time at the mobile station 10, which is transmitted from the mobile station 10 to the base stations 12 by a radio wave and obtained via the base stations 12 which receive the radio waves for example. Therefore, (Tr₁−Tₛ) (i=1, 2, . . . ) on the right-hand side of each equation of the equations (1) represents a propagation time of the radio wave from the mobile station 10 to the base station 12, and c×(Trᵢ−Tₛ) represents a distance between the mobile station 10 and the base station 12i. The equations (1) are simultaneous equations having x, y, and Ts as the unknowns. If Ts is eliminated from the equations (1), the following equations (s) are obtained.

$$\sqrt{{( x - {x}_{B 2} )}^{2} + {( y - {y}_{B 2} )}^{2}} - \sqrt{{( x - {x}_{B 1} )}^{2} + {( y - {y}_{B 1} )}^{2}} = c \times ( {Tr}_{2} - {Tr}_{1} ) \\ \sqrt{{( x - {x}_{B 3} )}^{2} + {( y - {y}_{B 3} )}^{2}} - \sqrt{{( x - {x}_{B 1} )}^{2} + {( y - {y}_{B 1} )}^{2}} = c \times ( {Tr}_{3} - {Tr}_{1} ) \\ \sqrt{{( x - {x}_{B 4} )}^{2} + {( y - {y}_{B 4} )}^{2}} - \sqrt{{( x - {x}_{B 1} )}^{2} + {( y - {y}_{B 1} )}^{2}} = c \times ( {Tr}_{4} - {Tr}_{3} ) \qquad ( 2 )$$

By solving the equations (2), the unknowns x and y are obtained. Specifically, a solving method such as the Newton method is used to calculate the solution of the equations (2), i.e., the position of the mobile station 10. Since the mobile station 10 is moved along with the computer 18, the calculated position of the mobile station 10 also is the position of the computer 18.

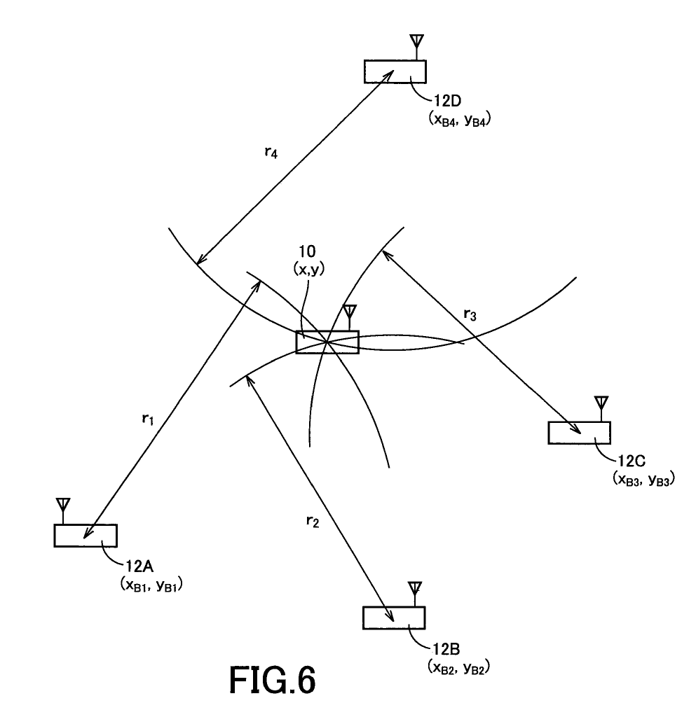

In FIG. 6, the arrangement of the base stations 12 is different from that of FIG. 1 for the purpose of description. In FIG. 6, r₁ to r₄ denote distances between the first base station 12A to the fourth base station 12D respectively and the mobile station 10 and correspond to the square root on the right-hand side of each equation of the equations (1). Therefore, the calculation of the solution of the equations (1) is performed by calculating the intersecting point of a circle with a diameter r₁ around the first base station 12A, a circle with a diameter r₂ around the second base station 12B, a circle with a diameter r₃ around the third base station 12C, and a circle with a diameter r₄ around the fourth base station 12D in FIG. 6. On the other hand, since the equations (1) are changed to the equations (2) and the equations (2) do not include Ts, the position of the mobile station 10 can be calculated without the need for the radio wave transmission time at the mobile station 10.

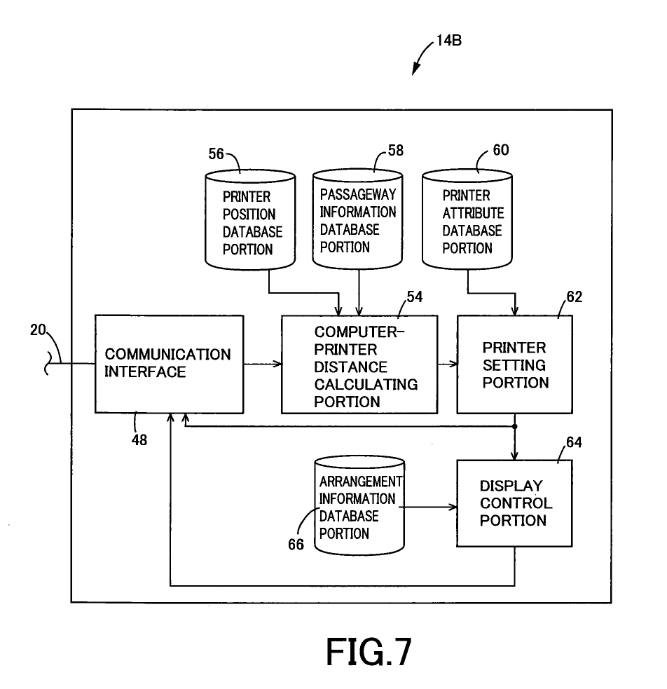

The functions included in the electronic control device 72 of the application server 14B depicted in FIG. 7 are implemented by a program executed in the server 14 of FIG. 4, for example.

A computer-printer distance calculating portion 54 determines a distance between each of a plurality of the printers 16 and the mobile station 10. For the positions of the plurality of the printers 16, those stored in a printer position database portion 56 are used. For the position of the mobile station 10, the value calculated by the positioning portion 50 of the positioning server 14A is used that is transmitted from the positioning server 14A through the communication cable 20 to the application server 14B. The computer-printer distance calculating portion 54 corresponds to a distance determining portion of the present invention.

The printer position database portion 56 stores the information of the positions of the plurality of the printers 16 for each printer as described above in a predetermined area of the storage device 74 of the application server 14B, for example. As depicted in FIG. 8, the storage is achieved to indicate that a printer having a printer name of PRN1 is located at the position of (x_{P1},y_{P1}), that a printer having a printer name of PRN2 is located at the position of (x_{P2},y_{P2}), and that a printer having a printer name of PRN3 is located at the position of (x_{P3},y_{P3}), for example. The positions of the printers are known positions set in advance. The positions of the printers are represented based on the coordinates in common with the coordinates used for representing the positions of the mobile station 10 and the base stations 12 (see FIG. 1).

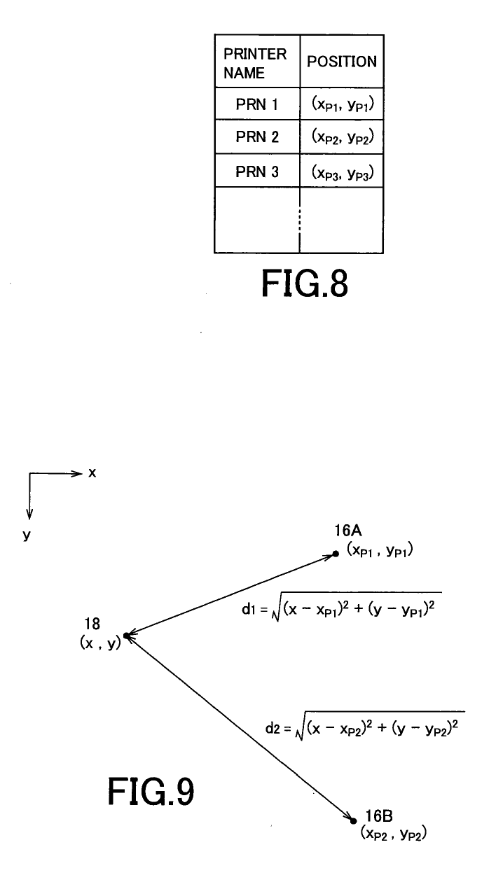

As depicted in FIG. 9, it the positions of the mobile station 10, the first printer 16A, and the second printer 16B are (x,y), (x_{P1},y_{P1}), and (x_{P1},y_{B2}), respectively, the computer-printer distance calculating portion 54 calculates a distance d₁ between the first printer 16A and the mobile station 10 and a distance d₂ between the second printer 16B and the mobile station 10 as represented by the following equations (3).

d₁=\sqrt{(x−xₚ₁)²+(y−y_{P1})²}

d₂=\sqrt{(x−xₚ₂)²+(y−y_{P2})²} (3)

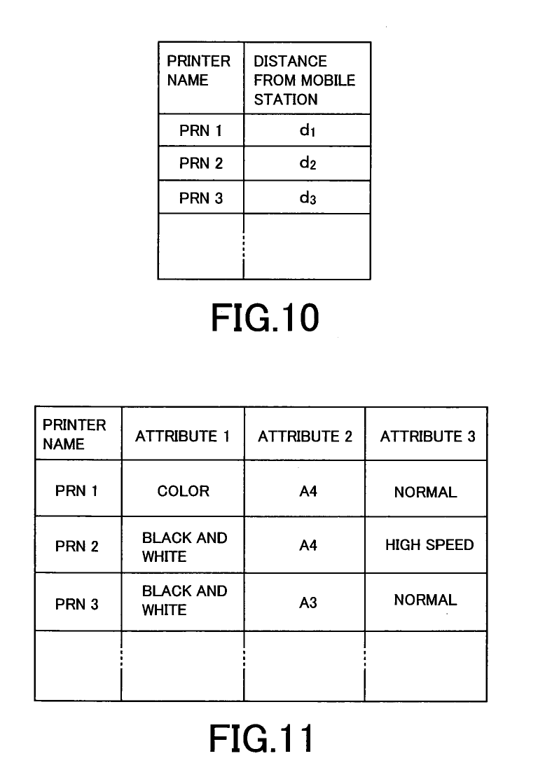

FIG. 10 depicts a distance between each of a plurality of the printers 16 and the mobile station 10 calculated by the computer-printer distance calculating portion 54 and the distances are temporarily stored in the storage device 74, for example, and used in a printer setting portion 62 described later.

Referring to FIG. 7 again, a printer attribute database portion 60 stores information related to attributes of each of the plurality of the printers 16 in advance in a predetermined area of the storage device 74 of the application server 14B, for example. FIG. 11 is a diagram for explaining an example of information stored in the printer attribute database portion 60, which stores information about whether a printer supports color printing or black-and-white printing, information about a size of a paper sheet capable of being output by a printer, and information about whether high-speed printing is supported, for each of the printers 16.

The printer setting portion 62 sets the printer 16 that performs output corresponding to an output request from the computer 18 among the plurality of the printers 16. Specifically, the printer setting portion 62 selects the printers 16 having the attributes capable of satisfying the output request from the computer 18 in terms of the printing performance, the valid periods of consumable supplies, etc., based on the information about the attributes of each of the plurality of the printers 16 stored in the printer attribute database portion 60 and the contents of the output request from the computer 18. Among the selected printers 16, the printer setting portion 62 sets a printer having the shortest distance to the computer within a preset space defined by the number and arrangement of the base stations 12, for example, within the same room as the mobile stations 10, as the printer 16 that performs the output corresponding to the output request from the computer 18, based on the distances between the plurality of the printers 16 and the mobile station 10 calculated by the computer-printer distance calculating portion 54.

For example, if the contents of the print request from the computer 18 indicate color printing on an A4 sheet, the print setting portion 62 selects the printers 16 capable of such printing based on the printer attribute database portion 60 as depicted in FIG. 11. Among the selected printers 16, the print setting portion 62 selects the printer having the shortest distance among distances, which is calculated by computer-printer distance calculating portion 54, between each of the plurality of the printers 16 and the mobile station 10 (FIG. 10) as the printer 16 that performs the output corresponding to the output request from the computer 18.

An arrangement information database portion 66 stores arrangement information about arrangement positions where arranged objects, for example, furniture such as desks, bookshelves, or partitions are disposed around the place surrounding the printer selection system of the embodiment, into a predetermined area of the storage device 74 of the application server 14B, for example. This arrangement information is entered by a user, etc., and stored in advance. Specifically, for example, the arrangement information database portion 66 may store the layout of the arranged objects as a drawing or may store information that uses coordinates to represent the positions and sizes of areas occupied by the arranged objects. In this case, the arrangement information is represented by using the coordinates in common with those used for representing the positions of the mobile station 10, the base stations 12, and the printers 16.

A display control portion 64 displays information about the printer set by the printer setting portion 62 as the printer that performs the output corresponding to the output request from the computer 18, on an output device 92 described later of the computer 18. Specifically, for example, the display control portion 64 creates an arrangement view based on the arrangement information stored in the arrangement information database portion 66. The display control portion 64 then generates display contents by illustrating the information about the position of the printer set by the printer setting portion 62, which is stored in the printer position database portion 56, and the information about the position of the mobile station 10 calculated by the positioning portion 50 of the positioning server 14A in the created arrangement view. The display control portion 64 transmits the generated display contents through the communication interface 48, the communication cable 20, and the access point 19 to the computer 18 to display the display contents on the output device 92, etc., of the computer 18.

A passageway information database portion 58 is used in another embodiment and will therefore be described later. In this embodiment, the passageway information database portion 58 is not necessary.

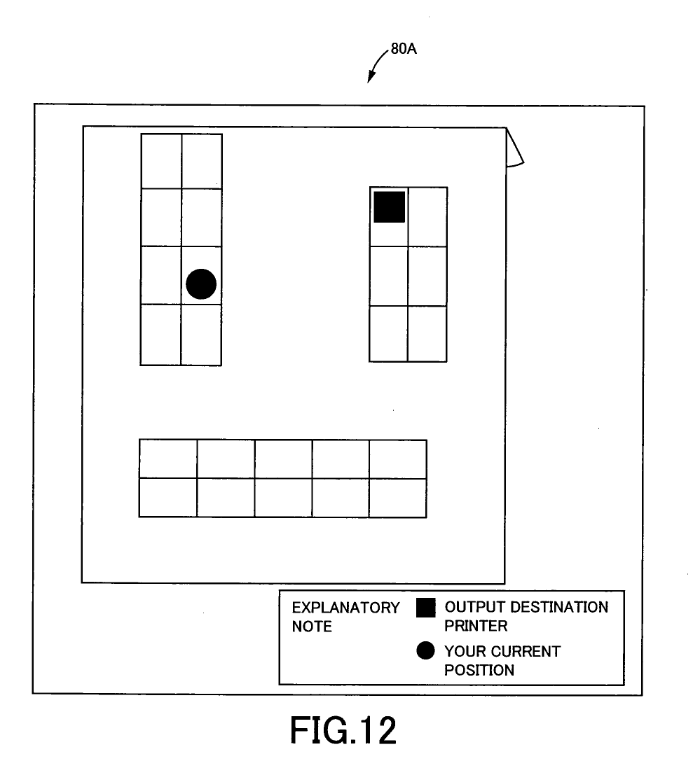

FIG. 12 is a schematic of an example of the display contents displayed by the display control portion 64 on the output device 92, etc., of the computer 18. In FIG. 12, display 80A displays an arrangement view in a room with the printer selection system 9 of the embodiment disposed and the arrangement view includes a black square representative of the position of the printer set by the printer setting portion 62, which is stored in the printer position database portion 56 and a black circle representative of the position of the mobile station 10 calculated by the positioning portion 50 of the positioning server 14A. In the display 80A of FIG. 12, the arrangement view, i.e., a portion other than the black square, the black circle, and information displayed as an explanatory note is generated based on the information stored in the arrangement information database portion 66.

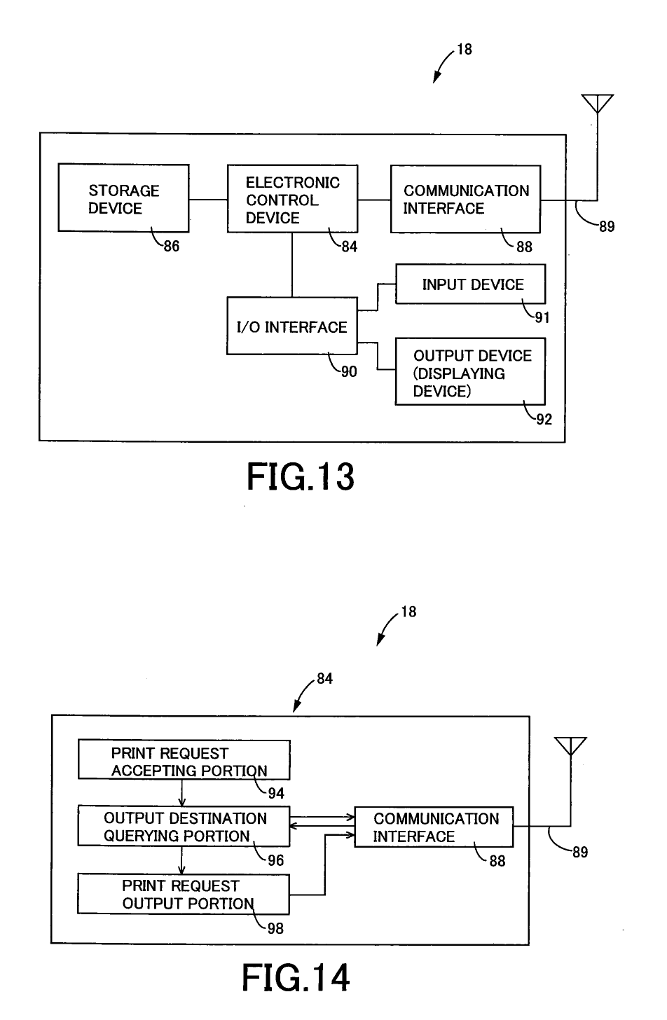

FIG. 13 is a schematic of the configuration of the computer 18. As depicted in FIG. 13, the computer 18 includes a so-called computer equipped with an electronic control device 84 corresponding to CPU, a storage device 86 corresponding to RAM, ROM, or a hard disc, an I/O interface 90, an input device 91 such as a keyboard and a mouse connected to the I/O interface 90, an output device 92 for display such as a displaying device, a communication interface 88, etc. The CPU can execute a signal process in accordance with a program stored in the ROM in advance while utilizing a temporary storage function of the RAM.

The communication interface 88 transmits/receives radio waves by using, for example, an antenna 89 to perform information communication with the access point 19, etc., through radio communication. The communication interface 88 transmits, for example, a query for the application server 14B of the printer that is the output destination when an output request is made and information about the contents of the output performed by the printer in response to the output request to the printer. The communication interface 88 receives information about the contents to be displayed on the output device 92 of the computer 18 from the display control portion 64 of the application server 14B to the computer 18.

As depicted in FIG. 14, a print request accepting portion 94 accepts an output request from another program running on the computer 18 and output data for the output. At this timing, the print request accepting portion 94 accepts the output request as the output from the printer nearest to the current position without identifying a printer that actually performs the output.

If the print request accepting portion 94 accepts an output request, an output destination querying portion 96 requests the application server 14B to set a printer capable of performing the output corresponding to the output request in terms of the printing performance, the valid periods of consumable supplies, etc. The output destination querying portion 96 receives information about the printer set by the printer setting portion 62 of the application server 14B.

A print request output portion 98 defines the output destination of the output request accepted by the print request accepting portion 94 as the printer 16 set by the printer setting portion 62 of the application server 14B due to the output destination querying portion 96 and wirelessly transmits the output data for the output corresponding to the output request to the output destination with the communication interface 88. The output data is transmitted through the access point 19 and the communication cable 20 to the printer 16.

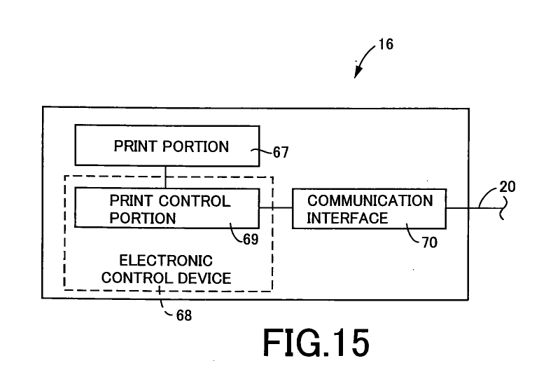

As depicted in FIG. 15, the printer 16 includes a print portion 67, an electronic control device 68, a communication interface 70, etc. The electronic control device 68 includes a so-called microcomputer equipped with CPU, RAM, ROM, and I/O interface, for example, and the CPU executes a signal process in accordance with a program stored in the ROM in advance while utilizing a temporary storage function of the RAM to execute a process in a print control portion 69 described later, etc.

The print portion 67 executes the print output in accordance with the output data transmitted to the printer 16.

The print control portion 69 is implemented by the electronic control device 68 and performs control related to the operation of the printer 16. Specifically, for example, the communication interface 70 described later is controlled to execute processes such as receiving the output data transmitted from another computer through the communication cable 20 or driving the print portion 67 to perform the print output of the received contents.

The communication interface 70 performs information communication with the computer 18 connected through the communication cable 20 or the computer 18 connected wirelessly to the access point 19 connected to the communication cable 20. Specifically, the communication interface 70 receives a command for performing the output by the printer 16, the output data, etc., from the computer 18.

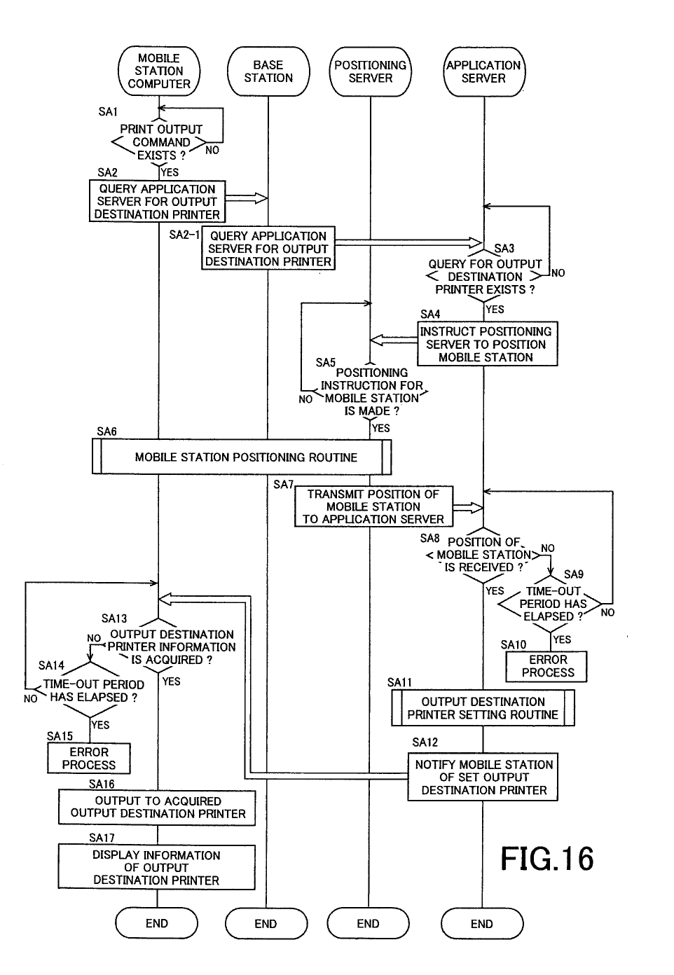

FIG. 16 is a flowchart for explaining an example of the control operation of the printer selection system 9 of this embodiment and is a diagram for explaining the control operation executed among the mobile station 10, the computer 18, the base station 12, the positioning server 14A, and the application server 14B.

First, at step (hereinafter, “step” will be omitted) SA1 corresponding to the print request accepting portion 94 of the computer 18, it is determined whether an output request for performing output from the nearest printer is accepted without identifying a printer acting as the output destination. If the output request is accepted, the determination at this step is affirmed and SA2 is executed. On the other hand, if the output request is not accepted, SA1 is repeatedly executed to wait for the output request to be accepted.

At SA2 corresponding to the output destination querying portion 96 of the computer 18, a request is made to the application server 14B for setting a printer that performs the output corresponding to the output request, i.e., a query is made about the output destination printer. For this query, for example, a request signal is wirelessly transmitted from the computer 18, once received by the base station 12 including the base station radio portion 32 as a radio communication interface and the communication interface 42 as a wire communication interface, and then transmitted at SA2-1 by the base station 12 through the communication cable 20 to the application server 14B. At SA3, the application server 14B waits until the computer 18 makes the request at SA2. If the request at SA2 from the computer 18 is received, the determination at this step is affirmed and SA4 is subsequently executed. On the other hand, if the request at SA2 from the computer 18 is not received, the determination at this step is denied and SA3 is repeatedly executed to wait until the request at SA2 from the computer 18 is received.

At SA4, the application server 14B transmits a command for positioning the mobile station 10 to the positioning server 14A. At SA5, the positioning server 14A waits until the application server 14B makes the request at SA4. If the request at SA4 from the application server 14B is received, the determination at this step is affirmed and SA6 is subsequently executed. On the other hand, if the request at SA4 from the application server 14B is not received, the determination at this step is denied. SA5 is repeatedly executed to wait until the request at SA4 from the application server 14B is received.

SA6 is a step executed if the determination at SA5 is affirmed, i.e., if the computer 18 makes the request for setting the printer that performs the output and the positioning server 14A receives the command from the application server 14B for performing the positioning of the mobile station 10, and a mobile station positioning routine for positioning the mobile station 10 is executed by the mobile station 10, the base station 12, and the positioning server 14A.

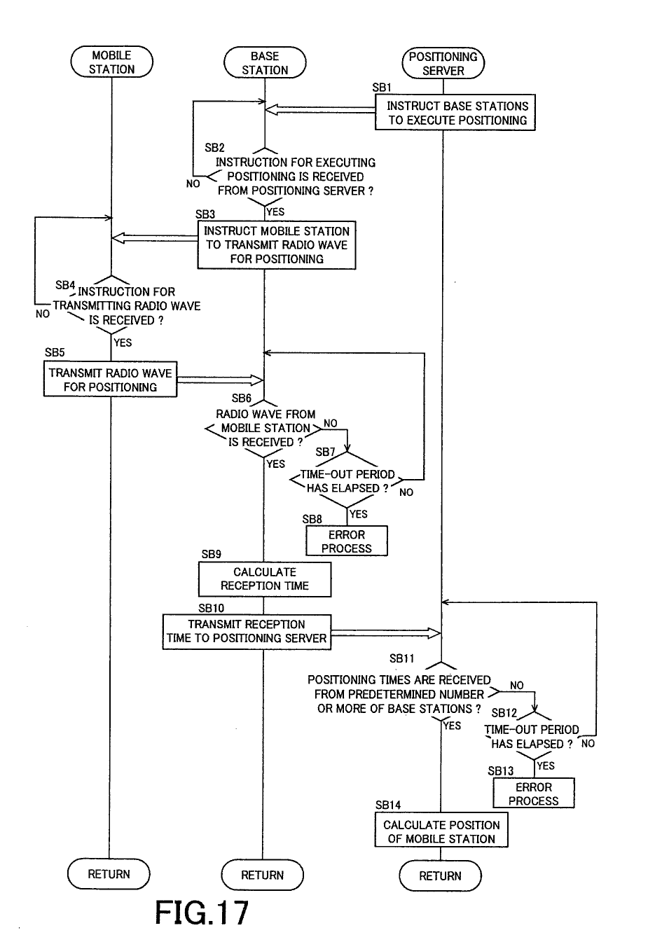

FIG. 17 explains the mobile station positioning routine. First, at step (hereinafter, “step” will be omitted) SB1, the positioning server 14A gives a command for executing the positioning of the mobile station 10 to each of the base stations 12. This command includes (1) a command causing the base station radio portion 32 of the base station 12 to transmit to the mobile station 10 a command for driving the mobile station 10 to transmit a radio wave for the positioning to one of a plurality of the base stations 12 and (2) a command causing each of a plurality of the base stations 12 to receive the radio wave for the positioning transmitted from the mobile station 10, detect a reception time, and transmit the detected reception time to the positioning server 14A. The command of (1) is given because the positioning server 14A does not have a function of transmitting/receiving radio waves for radio communication and a command from the positioning server 14A to the mobile station 10 must be given through the base station radio portion 32 of one of the base stations 12, and the one of the base stations 12 is an arbitrary selected base station 12, for example.

At SB2, the base stations 12 wait until the command at SB1 from the positioning server 14A is received. If the command at SB1 from the positioning server 14A is received, the determination at this step is affirmed and SB3 is subsequently executed. On the other hand, if the command at SB1 from the positioning server 14A is not received, the determination at this step is denied and SB1 is repeatedly executed to wait until the command at SB1 from the positioning server 14A is received.

At SB3, the command from the positioning server 14A received at SB2 is executed. Specifically, the base station 12 receiving the command of (1) wirelessly transmits to the mobile station 10 a command for driving the mobile station 10 to transmit the radio wave for the positioning. The base station 12 receiving the command of (2) receives the radio wave for the positioning transmitted from the mobile station 10.

At SB4, the mobile station 10 waits until the command (SB3) for transmitting the radio wave for the positioning is received. If the mobile station 10 receives the command for transmitting the radio wave for the positioning, the determination at this step is affirmed and SB5 is subsequently executed. On the other hand, if the command for transmitting the radio wave for the positioning is not received, the determination at this step is denied and SB4 is repeatedly executed to wait until the command for transmitting the radio wave for the positioning is received.

At SB5 corresponding to the mobile station radio portion 22 of the mobile station 10, etc., the mobile station 10 transmits the radio wave for the positioning. The radio wave for the positioning includes a spread code for detecting the reception time.

At SB6 corresponding to the base station radio portions 32 of the base stations 12, etc., it is determined whether the radio wave for the positioning transmitted from the mobile station 10 is received. If the radio wave transmitted from the mobile station 10 is received, the determination at this step is affirmed and SB9 is subsequently executed. On the other hand, if t the radio wave transmitted from the mobile station 10 is not received, the determination at this step is denied and SB7 is subsequently executed.

At SB7, it is determined whether an elapsed time from the start of reception of the radio wave from the mobile station exceeds a preset time-out period. If the elapsed time exceeds the time-out period, the determination at this step is affirmed and SB8 is executed. If the elapsed time does not exceed the time-out period, the determination at this step is denied and the radio wave from the mobile station 10 is continued to be received.

At SB8, the base station with the determination affirmed at SB7 determines that the radio wave from the mobile station 10 was unable to be received and executes an error process. Specifically, for example, information is transmitted to the positioning server 14A to indicate that the radio wave from the mobile station 10 was not received.

At SB9 corresponding to the reception time detecting portion 38, a correlation value is calculated between the spread code included in the radio wave for the positioning from the mobile station 10 received at SB6 and a replica code of the spread code stored in the base stations in advance and a time of the correlation value achieving a peak is detected as the reception time of the radio wave from the mobile station 10.

At SB10, the base stations 12 transmit to the positioning server 14A the information about the reception time of the radio wave from the mobile station 10 detected at SB9.

At SB11, it is determined whether the information about the reception time of the radio wave from the mobile station 10 at the base stations 12 is transmitted from the number of the base stations 12 equal to or greater than a predetermined number defined in advance and received by the positioning server 14A. The predetermined number is the number necessary for calculating the position of the mobile station 10 at following SB14 and is, for example, four if the mobile station 10 moves within a three-dimensional space or three in the case of a two-dimensional surface or even in the case of a three-dimensional space if information about the height of the mobile station 10 can be acquired from a height detecting means not shown, etc. If the information about the reception time is received from the number of the base stations 12 equal to or greater than the predetermined number, the determination at this step is affirmed and SB14 is subsequently executed. On the other hand, if the information about the reception time is not received from the number of the base stations 12 equal to or greater than the predetermined number, the determination at this step is denied and SB12 is subsequently executed.

At SB12, it is determined whether an elapsed time after giving the command at SB1 exceeds a preset time-out period. If the elapsed time exceeds the time-out period, the determination at this step is affirmed and SB13 is executed. If the elapsed time does not exceed the time-out period, the determination at this step is denied and the information about the reception time from the base stations 12 is continued to be received.

At SB13 executed if the determination at SB12 is affirmed, it is determined that the reception time of the radio wave from the mobile station 10 was unable to be received from the number of the base stations 12 necessary for calculating the position of the mobile station 10 and an error process is executed. Specifically, for example, information is transmitted to the application server 14B to indicate that the calculation of the position of the mobile station 10 failed.

At SB14 corresponding to the positioning portion 50 of the positioning server 14A, the position of the mobile station 10 is calculated based on the information about the reception time of the radio wave from the mobile station 10 at the base stations 12 received at SB11. Specifically, the equations (2) are solved based on the information about the reception time of the radio wave from the mobile station 10 at the base stations 12 and the information related to the already known positions of the base stations 12 to calculate the position of the mobile station 10.

Referring to FIG. 16 again, at SA7, the positioning server 14A transmits to the application server 14B the information about the position of the mobile station 10 calculated by the mobile station positioning routine at SA6.

At SA8, it is determined whether the information about the position of the mobile station 10 is transmitted from the positioning server 14A and received by the application server 14B. If the information about the position of the mobile station 10 is received by the application server 14B, the determination at this step is affirmed and SA11 is subsequently executed. On the other hand, if the information about the position of the mobile station 10 is not received by the application server 14B, the determination at this step is denied and SA9 is subsequently executed.

At SA9, it is determined whether an elapsed time after giving the command at SA4 exceeds a preset time-out period. If the elapsed time exceeds the time-out period, the determination at this step is affirmed and SA10 is executed. If the elapsed time does not exceed the time-out period, the determination at this step is denied and the information about the position of the mobile station from the positioning server 14A is continued to be received.

At SA9 executed if the determination at SA9 is affirmed, it is determined that the information about the position of the mobile station 10 was not acquired and an error process is executed. Specifically, for example, information may be transmitted to the computer 18 to indicate that the nearest printer was unable to be determined or SA4 and later may be executed again.

At SA11 executed if the determination at SA8 is affirmed, an output destination printer setting routine is executed for setting a printer acting as the output destination in response to the query performed at SA2.

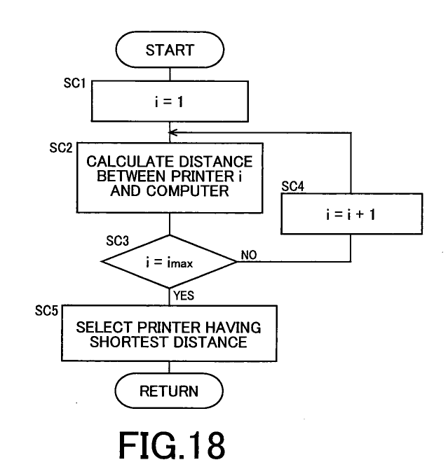

FIG. 18 is a flowchart for explaining the control operation of the output destination printer setting routine. SC1 to SC4 correspond to the computer-printer distance calculating portion 54. At SC1, a value of a variable i for identifying printers subjected to the calculation of distance from the mobile station 10 in this routine is set to one as an initializing process.

Subsequently, at SC2, a distance between the printer 16 and the mobile station 10 is calculated for an ith printer based on the method described earlier in FIG. 9. The position of the printer 16 is used as that stored in the printer position database portion 56 in advance and the position of the mobile station 10 is used as the value calculated in the mobile station positioning routine at SA6 and received by the application server 14B at SA8. The distance between the printer 16 and the mobile station 10 is calculated as the linear distance therebetween.

At SC3, it is determined whether the distance between the printer 16 and the mobile station 10 is calculated for all the printers 16. If the distance between the printer 16 and the mobile station 10 is calculated for all the printers 16, the determination of this step is affirmed and SC5 is subsequently executed. On the other hand, if the distance between the printer 16 and the mobile station 10 is not calculated for all the printers 16, the determination of this step is denied and SC4 is executed. At SC4, the value of the variable i is incremented by one to calculate a distance between another printer 16 and the mobile station 10 and SC2 and later are then repeatedly executed.

At SC5 corresponding to the printer setting portion 62, the printer 16 having the shortest distance is selected within a preset space defined by the number and arrangement of the base stations 12, for example, within the same room as the mobile station 10, from the calculations of distances between the printers 16 and the mobile station 10 calculated for all the printers 16 by repeatedly executing SC2 to SC4.

Referring to FIG. 16 again, at SA12 corresponding to the display control portion 64, etc., the application server 14B transmits to the computer 18 the information about the output destination printer set as the output destination in the output destination printer setting routine at SA11 and the display contents to be displayed for the output destination printer on the output device 92 of the computer 18.

At SA13, it is determined whether the information about the output destination printer is transmitted from the application server 14B and received by the computer 18. If the information about the output destination printer is received by the computer 18, the determination at this step is affirmed and SA16 is executed. On the other hand if the information about the output destination printer is not received by the computer 18, the determination at this step is denied and SA14 is subsequently executed.

At SA14, it is determined whether an elapsed time after making the query at SA2 exceeds a preset time-out period. If the elapsed time exceeds the time-out period, the determination at this step is affirmed and SA15 is executed. If the elapsed time does not exceed the time-out period, the determination at this step is denied and the information about the output destination printer from the application server 14B is continued to be received.

At SA15 executed if the determination at SA14 is affirmed, it is determined that the information about the output destination printer was unable to be received and an error process is executed. Specifically, for example, this error process may be a process of discarding the output command accepted at SA1 because the printer acting as the output destination cannot be found or a process of causing the process after SA2 to be executed again.

At SA16 corresponding to the print request output portion 98 of the computer 18, the printer performing the output corresponding to the output request accepted at SA1 is set to the output destination printer received at SA13 and the data for the output is transmitted to the output destination printer.

At SA17 corresponding to the output device 92 of the computer 18, etc., the output device 92 displays the information about the output destination printer received at SA13, to which the data for the output is transmitted at SA16. This display is performed based on the display contents generated at SA12 and is performed by graphically indicating the position of the mobile station 10 and the position of the output destination printer on the arrangement view as in the display 80A depicted in FIG. 12, for example.

According to the embodiment, the positioning portion 50 included in the positioning server 14A connected to the computer 18 in a data communicable manner calculates the position of the mobile station 10 as the position of the computer 18 based on the reception results of the radio wave for the position detection transmitted from the mobile station 10 moved along with the computer 18 and received by the plurality of the base stations 12; the computer-printer distance calculating portion 54 calculates a distance between a position of each of the plurality of the printers 16 stored in the printer position database portion 56 and the position of the computer 18 calculated by the positioning portion 50; the printer setting portion 62 sets the printer 16 having the shortest distance as the output destination printer 16 for performing the output from the computer 18 by calculating a distance between each of the plurality of the printers 16 and the computer 18 based on the position of each of the plurality of the printers 16 calculated by the computer-printer distance calculating portion 54 and the position of the computer 18 calculated by the positioning portion 50; and, therefore, the printer 16 nearest to the position of the computer 18 at the time of the output request to the printer 16 is selectable as the printer 18 that performs the output in response to the output request from the computer 18.

According to the embodiment, since the computer-printer distance calculating portion 54 calculates a distance between a position of each of the plurality of the printers 16 stored in the printer position database portion 56 and the position of the computer 18 calculated by the positioning portion 50 as the linear distances therebetween, a distance between the computer 18 and each of the plurality of printers 16 can easily be calculated and the printer 16 nearest to the position of the computer 18 at the time of the output request to the printer 16 is selectable as the printer 16 that outputs the output request from the computer 18.

According to the embodiment, since the printer setting portion 62 extracts the printers 16 satisfying the output request from the computer 18 based on the information related to the attributes of the plurality of the printers 16 stored in the printer attribute database portion 60 and sets the printer 16 having the shortest distance from the computer 18 calculated by the computer-printer distance calculating portion 54 among the extracted printers 16 as the output destination printer 16 that performs the output from the computer 18, the printer 16 nearest to the position of the computer 18 at the time of the output request to the printer 16 is selectable as the output destination printer 16 that outputs the output request from the computer 18 among the printers 16 capable of satisfying the output request to the printer 16.

According to the embodiment, since the display control portion 64 drives the displaying device 92 included in the computer 18 to display the information related to the position of the output destination printer 16 set by the printer setting portion 62, the information related to the position of the output destination printer 16 set by the printer setting portion 62 can be displayed.

According to the embodiment, since the arrangement information database portion 66 stores the positional information of arranged objects in advance and the display control portion 64 displays the positions of the output destination printer 16 set by the printer setting portion 62 and the computer 18 positioned by the positioning portion 50 on an arrangement view generated based on the positional information of arranged objects stored in the arrangement information database portion 66, the information related to the position of the output destination printer 16 can more comprehensively be displayed.

Another embodiment of the present invention will be described. The portions common to the embodiments are denoted by the same reference numerals and will not be described.

This embodiment relates to another aspect of the application server 14B. Specifically, this embodiment relates to the calculation of distance between the computer 18 and each of a plurality of the printers 16 by the computer-printer distance calculating portion 54 and the computer-printer distance calculating portion 54 calculates the distance by using information stored in the passageway information database portion 58 not used in the above embodiment.

In FIG. 7, the passageway information database portion 58 stores passageway information about a position of an area allowing passage of a user, i.e., an area representative of a passageway into a predetermined area of the storage device 74 of the application server 14B, for example. Specifically, for example, this passageway information may be stored as a drawing of the area representative of the passageway or may be stored as information about the position and size of the area representative of the passageway. In this case, the arrangement information is represented by using the coordinates in common with those representing the positions of the mobile station 10, the base stations 12, and the printers 16.

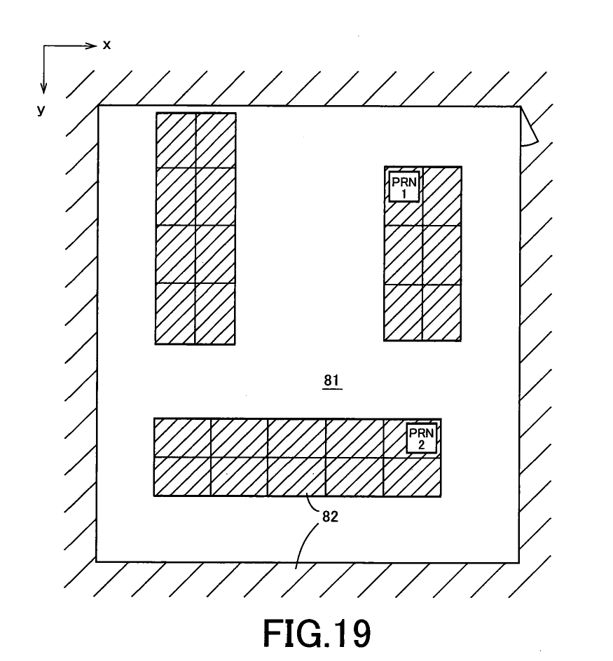

In FIG. 19, a shaded area 82 indicates a non-passageway area not allowing passage of a user. This non-passageway area 82 is an area unusable as a passageway for a user because the area is disposed with fixtures such as desks or is outside of the room disposed with the printer selection system 9 of this embodiment. On the other hand, a non-shaded area 81 is an area representative of a passageway. If a user of the computer 18 makes an output request and the output is performed in response to the output request, the user goes and backs between the position of the computer 18 and the position of the printer 16 set as the output destination printer within the passageway area 81 representative of the passageway.

Therefore, the computer-printer distance calculating portion 54 calculates a distance between each of the plurality of the printers 16 and the computer 18 based on the passageway information stored in the passageway information database portion 58 as a distance of a route set on the passageway between each of the plurality of the printers 16 and the computer 18.

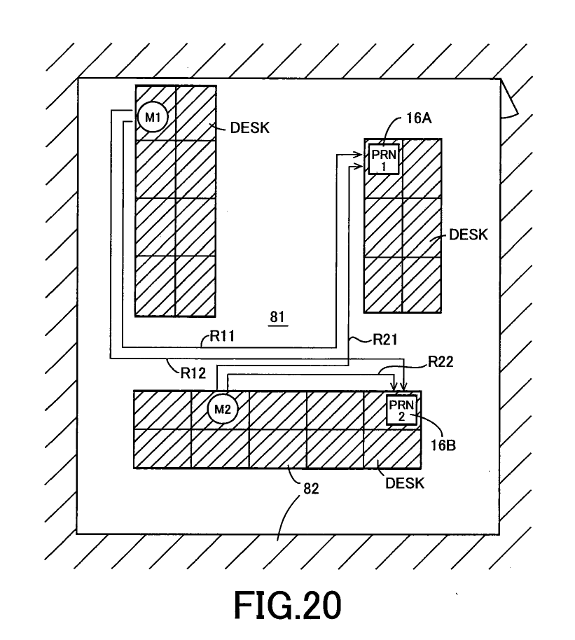

As depicted in FIG. 20, the computer-printer distance calculating portion 54 calculates the position of the mobile station 10 calculated by the positioning portion 50 of the positioning server 14A and the position of each of the plurality of the printers 16 as a distance of a route set within the passageway area 81. Specifically, for example, when PRN1, PRN2, and M2 of FIG. 20 indicate the positions of the first printer 16A, the second printer 16B, and the mobile station 10, respectively, as depicted in FIG. 20, a route from the position M2 of the mobile station 10 to the position PRN1 of the first printer 16A is set as R21; a route from the position M2 of the mobile station 10 to the position PRN2 of the second printer 16B is set as R22; and the distances thereof are calculated. Specifically, for example, the distances are obtained by accumulating lengths of line segments of the routes.

This enables the distance between the position of the mobile station 10 and the position of the printer 16 to be calculated as a distance approximating the distance of the actual movement of the user. Therefore, for example, as in the case that the position of the mobile station 10 calculated by the positioning portion 50 of the positioning server 14A is M1 of FIG. 20, even if the linear distance from the position M1 of the mobile station 10 to the position PRN1 of the first printer 16A is shorter than the linear distance from the position M1 of the mobile station 10 to the position PRN2 of the second printer 16B, a distance of R11 set as the route from the position M1 of the mobile station 10 to the position PRN1 of the first printer 16A is calculated longer than a distance of R12 set as the route from the position M1 of the mobile station 10 to the position PRN2 of the second printer 16B.

Since the computer-printer distance calculating portion 54 calculates a distance between the position of the mobile station 10 and each of a plurality of the printers 16 as a distance of a route set within the passageway area 81 and the printer setting portion 62 selects the printer 16 having the shortest distance of the route as the output destination printer, the output destination printer can be set as the printer 16 that shortens an actual movement length when a user moves from the position of the computer 18 to the output destination printer.

According to the embodiment, the computer-printer distance calculating portion 54 calculates a distance between a position of each of the plurality of the printers 16 and the position of the computer 18 calculated by the positioning portion 50 based on the information related to a position of a passageway that allows passage stored in the passageway information database portion 58 as a shortest distance among routes on the passageway linking each of the positions of the printers 16 with the position of the computer 18, the printer 16 nearest to the position of the computer 18 at the time of making an output request to the printer 16 is selectable as the printer 16 that outputs the output request from the computer 18 such that a distance required for actual movement of a user of the computer 18 is shortened between the computer 18 and the printer 16 that performs the output.

Another embodiment of the present invention will be described. This embodiment relates to the display control portion 64 of the application server 14B. In the embodiments, the display control portion 64 creates an arrangement view based on the arrangement information stored in the arrangement information database portion 66 and displays information about a position of the printer set as the output destination and information about a position of the mobile station 10 to generate the display contents.

In this embodiment, the display control portion 64 generates information about a name of the printer 16 set as the output destination by the printer setting portion 62 as the display contents. The generated display contents are transmitted through the communication interface 48, the communication cable 20, and the access point 19 to the computer 18 to display the display contents on the output device 92 of the computer 18, etc.

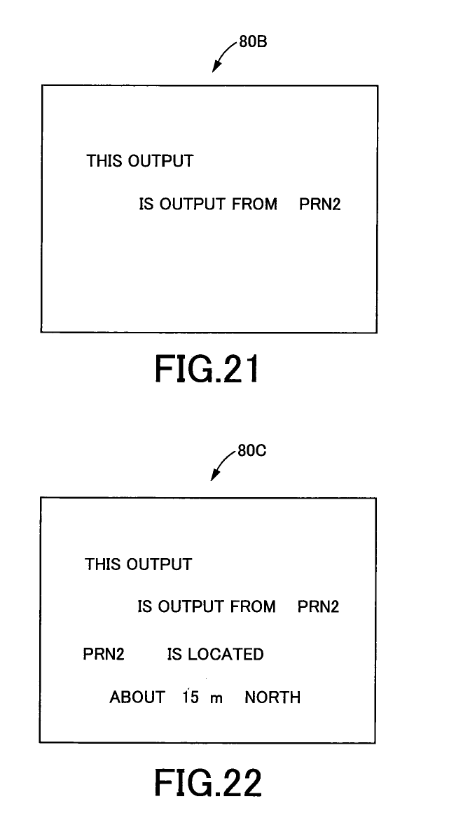

As depicted in FIG. 21, a display 80B on the output device 92 of the computer 18 displays information about a name (e.g., PRN2 in the example of FIG. 21) of the printer that performs the output corresponding to the output request from the computer 18.

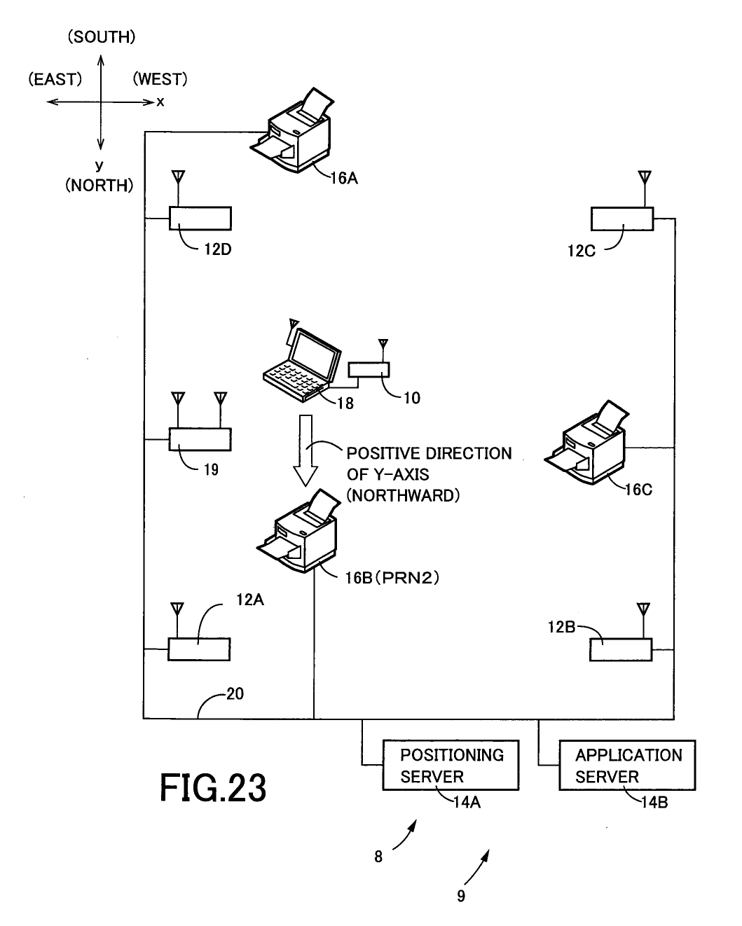

Since the position of the printer 16 is stored in the printer position database portion 56, a relative direction to the position of the printer 16 viewed from the position of the mobile station 10 or an orientation can be obtained. Therefore, the display contents can include the orientation of the printer 16 that performs the output from the computer 18. FIG. 22 depicts an example 80C of display on the output device 92 of the computer 18 in this case. For example, when the printer position database portion 56 stores that the y-axis defining the coordinates representative of the positions of the mobile station 10, the base station 12, and the printer 16 is northward as depicted in FIG. 23, if the relative direction of the position of the printer 16 (PRN2) viewed from the position of the mobile station 10 is the positive direction of the y-axis, i.e., if the mobile station 10 and the second printer 16B corresponding to the PRN2 have the same x-coordinates, the printer 16 set as the output destination is northward from the position of the mobile station 10. Therefore, the display control portion 64 generates information about the name of the selected printer and the orientation thereof as the display contents and displays the display contents as a display 80C on the output device 92 of the computer 18, etc.

Since the display contents generated by the display control portion 64 are simplified as compared to the display contents using the arrangement view, this reduces a calculation amount or a calculation time of the application server 14B required for the display.

According to the embodiment, since the display control portion 64 (SA12) displays information related to the position of the printer 16 set by the printer setting portion 62 (SA11) on the displaying device 92 included in the computer 18, a user can easily acquire the information related to the position of the printer 16 set by the printer setting portion 62.

Another embodiment of the present invention will be described. This embodiment relates to configurations of a computer 118 and a printer 116 making up a printer selection system 109. In the embodiments, the mobile station 10 is moved along with the computer 18 to calculate the position of the computer 18, and a plurality of the base stations 12 is disposed at known positions, receiving radio waves transmitted by the mobile station 10 for the positioning.

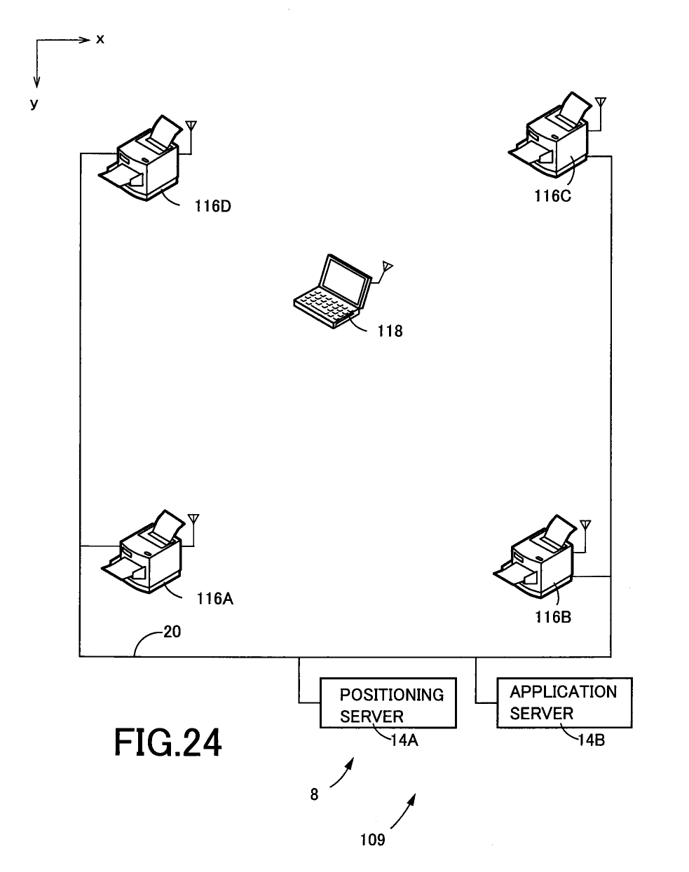

An example of the printer selection system 109 in this embodiment is depicted in FIG. 24. The computer 118 has the functions of the mobile station 10 of the embodiments and the printers 16 have the functions of the base stations 12 of the embodiments.

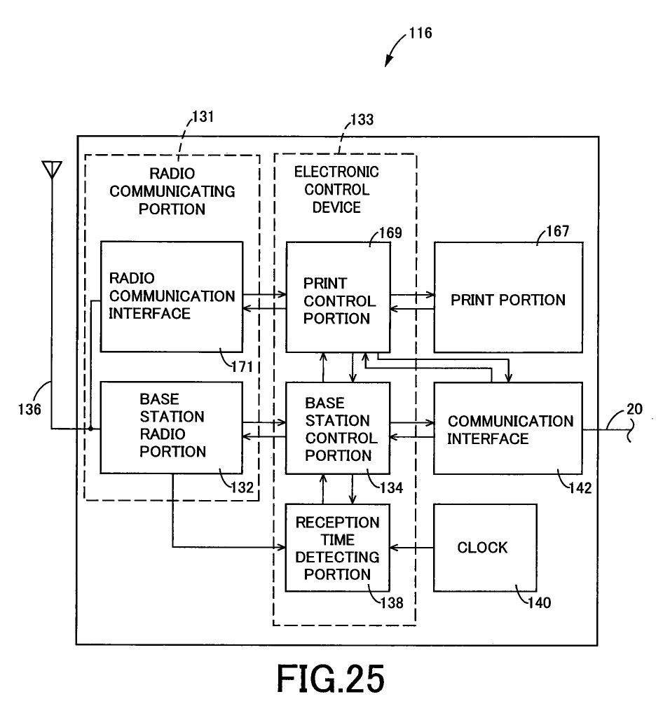

As depicted in FIG. 25, the printer 116 includes a print portion 167 that performs print output, an electronic control device 133, a radio communicating portion 131 that transmits/receives radio waves, a communication interface 142, a clock 140, an antenna 136, etc.

The electronic control device 133 includes a so-called microcomputer equipped with CPU, RAM, ROM, and I/O interface, for example. The CPU executes a signal process in accordance with a program stored in the ROM in advance while utilizing a temporary storage function of the RAM to execute process(es) in a print control portion 169 described later, etc.

The radio communicating portion 131 includes an oscillator that generates a carrier wave of a predetermined frequency, a modulator that modulates the carrier wave based on a signal to be transmitted through radio waves and that performs digital modulation, etc., and a transmission amplifier that amplifies the modulated carrier wave to a predetermined output power and is implemented by a reception amplifier that amplifies a reception wave received by the antenna 136, a filter that takes out only a predetermined frequency component from the reception wave, and a demodulator that performs digital demodulation or demodulation by a wave detector. For example, since so-called digital communication is preferably used for the radio communication performed by the radio communicating portion 131 in this case, the radio communicating portion 131 includes a mechanism for modulation or demodulation necessary for the digital communication.

The print portion 167 performs print output corresponding to the output data transmitted to the printer 16.

The print control portion 169 is implemented by the electronic control device 133 and performs control related to the operation of the printing output of the printer 116. Specifically, for example, the print control portion 169 executes processes such as controlling a communication interface 142 or a radio communication interface 171 described later to receive output data transmitted from another computer through the communication cable 20 or by transmitting/receiving radio waves for radio communication, and driving the print portion 167 to perform the print output of the received contents.

The communication interface 142 performs information communication with the server 14, etc., connected through the communication cable 20. Specifically, the communication interface 142 receives a command for performing the output by the printer 116, the output data, etc., from the computer 118 described later.

The radio communication interface 171 is implemented by the radio communicating portion 131 and performs information communication with another printer 116, the computer 118, etc., having a same radio communication interface through predetermined digital radio communication such as a standard regulated as a so-called wireless LAN.

The antenna 136 is used when radio communication is performed by the radio communication interface 171 and when a base station radio portion 132 described later transmits/receives a radio wave and an antenna suitable for a frequency of the radio wave to be transmitted/received is employed. An antenna nondirectional at least in the propagation direction of the radio waves is preferably used for the antenna 136 such that the radio waves can be received with the same intensity if the computer 118 exists at the same distances from the printers 116 regardless of the position of the computer 118, i.e., the directions of the computer 118 from the viewpoints of the printers 116.

The printer 116 also includes the clock 40, etc., included in the base stations 12 in the above embodiments. The radio communicating portion 131 operates as the base station radio portion 132 as well and the electronic control device 133 also executes processes in a base station control portion 134 and a reception time detecting portion 138.

The base station radio portion 132 corresponds to the base station radio portion 32 in the embodiments and is implemented by the radio communicating portion 131. The base station radio portion 132 uses the antenna 136 to transmit a radio wave including a command that controls the operation of the computer 118 as a mobile station to a mobile station control portion 122 of the computer 118. The base station radio portion 132 performs operations such as receiving a radio wave for positioning transmitted by a mobile station radio portion 124 of the computer 118 described later.

The base station control portion 134 and the reception time detecting portion 138 are implemented by the electronic control device 133 and correspond to the base station control portion 34 and the reception time detecting portion 38, respectively, in the embodiments. The base station control portion 134 controls the base station radio portion 132. Specifically, for example, the base station control portion 134 performs switch-over to transmission or reception, sets a carrier wave frequency, and sets the output power of the transmission amplifier for the base station radio portion 132. The setup values for these controls are determined as a result of communication with the positioning server 14A or the computer 118. The base station control portion 134 controls the execution of detection of a reception time and controls the request and acquisition of output of a reception time detection result for the reception time detecting portion 138. The base station control portion 134 analyzes the contents of the radio wave transmitted by the mobile station radio portion 124 of the computer 118 and received and decoded in the base station radio portion 132. In the same way, the base station control portion 134 analyzes the contents of the transmission from the positioning server 14A received by the communication interface 142 described later to take out a command related to the control operation of the printer 16. The base station control portion 134 transmits information necessary for another device through the communication interface 142 and the base station radio portion 32.

The reception time detecting portion 138 calculates a correlation value between a spread code included in the radio wave transmitted from the mobile station radio portion 124 of the computer 118 and a replica code of the spread code. Specifically, the reception time detecting portion 138 acquires the replica code same as the spread code to be transmitted by the mobile station radio portion 124 of the computer 118 in advance, and the replica code and the spread code (reception code) taken out from the received radio wave from the mobile station radio portion 124 of the computer 118 are input to a matched filter to acquire the correlation value between both codes. A time indicative of the peak of the correlation value is defined as the reception time of the radio wave. Therefore, the reception time is detected by acquiring the time indicative of the peak of the correlation value from the clock 140 described later.

The clock 140 measures time and corresponds to the clock 40 of the embodiments. For example, the clock 140 is used as a reference when the reception time detecting portion 138 detects the reception time. The printers 118 have their respective clocks 40 and the times thereof are synchronized in advance.

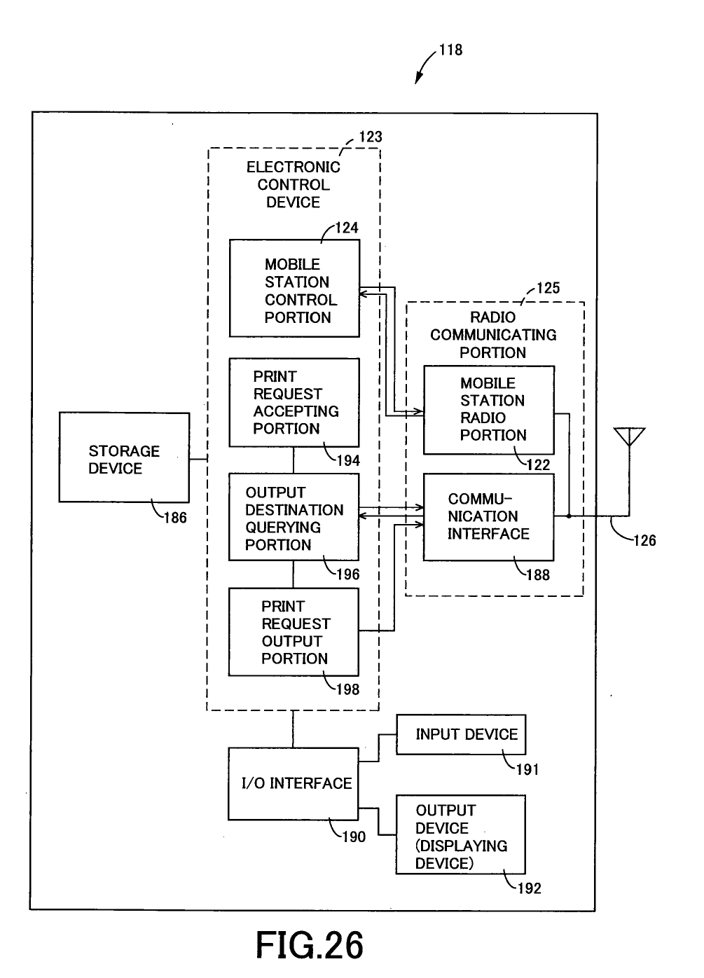

The computer 118 depicted in FIG. 26 includes a so-called computer equipped with an electronic control device 123 corresponding to CPU, a storage device 186 corresponding to RAM, ROM, or a hard disc, an I/O interface 190, an input device 191 such as a keyboard and a mouse connected to the I/O interface 190, an output device 192 for display such as a displaying device, a radio communicating portion 125 that transmits/receives radio waves, an antenna 126 used by the radio communicating portion 125 for the transmission/reception of the radio waves, etc., and the CPU can execute a signal process in accordance with a program stored in the ROM in advance while utilizing a temporary storage function of the RAM.

A communication interface 188 corresponds to the communication interface 88 in the embodiments and is a function implemented by the radio communicating portion 125. The communication interface 188 transmits/receives radio waves by using, for example, the antenna 126 to wirelessly perform information communication with the printer 116, etc. The communication interface 188 transmits, for example, a query for the application server 14B of the printer that is the output destination when an output request is made and information about the contents of the output performed by the printer in response to the output request to the printer and receives information about the contents to be displayed on the output device 192 of the computer 118 from the display control portion 64 of the application server 14B to the computer 118.

A print request accepting portion 194, an output destination querying portion 196, and a print request output portion 198 are functions implemented by the electronic control device 123 and correspond to the print request accepting portion 94, the output destination querying portion 96, and the print request output portion 98, respectively, in the embodiments. The print request accepting portion 194 accepts an output request from another program running on the computer 118 and output data for the output. At this timing, the print request accepting portion 194 accepts the output request as the output from the printer nearest to the current position without identifying a printer that actually performs the output.

If the print request accepting portion 194 accepts an output request, the output destination querying portion 196 requests the application server 14B to set a printer that performs the output corresponding to the output request and receives information about the printer set by the printer setting portion 62 of the application server 14B.

The print request output portion 198 defines the output destination of the output request accepted by the print request accepting portion 194 as the printer 116 set by the printer setting portion 62 of the application server 14B due to the output destination querying portion 196 and wirelessly transmits the output data for the output corresponding to the output request to the output destination, i.e., the printer 116 defined as the output destination, with the communication interface 88.

The electronic control device 123 of the computer 118 also implements the mobile station control portion 124 corresponding to the mobile station control portion 24 of the mobile station 10 in the above embodiments and the radio communicating portion 125 implements the mobile station control portion 124 corresponding to the mobile station radio portion 122 of the mobile station 10 in the above embodiments.

The mobile station radio portion 122 corresponds to the mobile station radio portion 22 of the mobile station 10 in the embodiments and is implemented by the radio communicating portion 125. The mobile station radio portion 122 implements a so-called radio communication function and uses the antenna 126 to transmit/receive radio waves. For example, the mobile station radio portion 122 transmits radio waves including a spread code for calculating a correlation value to the printer 116. The mobile station radio portion 122 receives radio waves transmitted from the base station radio portion 132 of the printer 116 including a command for the operation of the computer 118. The mobile station radio portion 122 includes an oscillator that generates a carrier wave of a predetermined frequency, modulator that modulates the carrier wave based on a signal to be transmitted through radio waves and that performs digital modulation, etc., and a transmission amplifier that amplifies the modulated carrier wave to a predetermined output power. The mobile station radio portion 122 also has a reception function implemented by a reception amplifier that amplifies a reception wave received by the antenna 126, a filter that takes out only a predetermined frequency component from the reception wave, and a demodulator that performs digital demodulation or demodulation by a wave detector. For example, since so-called digital communication is preferably used for the radio communication performed by the mobile station radio portion 122 in this case, the mobile station radio portion 22 includes a mechanism for modulation or demodulation necessary for the digital communication.

The antenna 126 is used when the mobile station radio portion 122 transmits/receives a radio wave and an antenna suitable for a frequency of a radio wave to be transmitted/received is employed. An antenna nondirectional at least in the propagation direction of the radio waves is preferably used for the antenna 126 such that the printers 116 at the same distances from the antenna 126 can receive the radio waves with the same intensity regardless of directions from the computer 118 if the distances from the computer 118 are the same.

The mobile station control portion 124 corresponds to the mobile station control portion 124 of the mobile station 10 in the embodiments, is implemented by the electronic control device 123, and controls the mobile station radio portion 122. Specifically, for example, the mobile station control portion 124 performs switch-over to transmission or reception, sets a carrier wave frequency, and sets the output power of the transmission amplifier for the mobile station radio portion 122. The setup values for these controls are determined as a result of communication with the printer 116, for example, based on a command transmitted from the base station control portion 134 of the printer 116. The mobile station control portion 124 analyzes a command for the control operation of the computer 118 from the printer 116 by analyzing the contents of the radio wave from the printer 116 received and decoded in the mobile station radio portion 122. The mobile station control portion 124 reads a stored spread code from a storage means not shown, for example, or generates a spread code based on a predetermined generating method, for example, a primitive polynomial defined in advance to determine the spread code transmitted through radio waves by the mobile station radio portion 112 of the computer 118.

According to the embodiment, since the computer 118 has both the functions of the mobile station radio portion 122 and the mobile station control portion 124, i.e., the mobile station that transmits the radio wave for the positioning and the functions of the print request accepting portion 194, the output destination querying portion 196, and the print request output portion 198, i.e., the computer that makes an output request, the printer selection system 109 is more simply configured.

According to the embodiment, the printer 116 has both the functions of the print control portion 169, the print portion 167, the radio communication interface 171, and the communication interface 142, i.e., the printer for performing the output in response to the output request from the computer 118 and the functions of the base station radio portion 132, the base station control portion 134, the reception time detecting portion 138, and the clock 140, i.e., the base station that receives the radio wave for the positioning transmitted from the mobile station, the printer selection system 109 is more simply configured.

Although the embodiments of the present invention have been described in detail with reference to the drawings, the present invention is also applied to other aspects.

For example, although a plurality of the base stations 12 (116) receives the radio wave transmitted from the mobile station 10 (118) to calculate the position of the mobile station 10 (118) based on the reception times at the base stations 12 (116) in the embodiments, such an aspect is not a limitation. For example, when each of a plurality of the base stations 12 (116) transmits a radio wave for positioning and the mobile station 10 (118) receives the radio waves transmitted from the plurality of the base stations 12 (116) to detect the reception times of the radio waves, the position of the mobile station 10 (118) can be calculated as in the embodiments based on the information about the detected reception times and the information about the known positions of the plurality of the base stations 12 (116). When the mobile station 10 (118) transmits a radio wave with a predetermined output power and a plurality of the base stations 12 (116) detects a reception intensity of the radio wave, the distances between the plurality of the base stations 12 (116) and the mobile station 10 (118) are calculated to derive equations corresponding to the equations (1) based on the reception intensities of the detected radio wave and information about a pre-calculated relationship between a reception intensity of a radio wave at a base station and a distance from the base station to the mobile station that transmits the radio wave, and the position of the mobile station 10 (118) may be calculated by solving these equations.

although the positioning server 14A and the application server 14B are provided as separate servers in the embodiments, such an aspect is not a limitation and one server may be used by implementing the functions of both the positioning server 14A and the application server 14B with one server. Conversely, the function of the positioning server 14A or the application server 14B can be implemented by a plurality of servers in terms of hardware.

Although the communication interface included in the computer 18 (118) is a radio communication interface that exchanges information by transmitting/receiving radio waves to/from another device or the access point 19 in the embodiments, this is not a limitation and the communication interface may be a communication interface exchanging information through the communication cable 20.

Although the display contents generated by the display control portion 64 are displayed by the displaying device 92 included in the computer 18 in the embodiments, this is not a limitation and, for example, if the printer 16 has a displaying device such as a liquid crystal displaying device, the display contents generated by the display control portion 64 may be transmitted through the communication cable 20 to the printer 16 and displayed by the displaying device.

Although the server 14 is connected to the base station 12 (116) and the printer 16 (116) through the communication cable in an information exchangeable manner, for example, as depicted in FIGS. 1 and 24 in the embodiments, such an aspect is not a limitation and, when the server 14, the base station 14, and the printer 16 have radio communication interfaces that enable mutual information exchange through radio communication, the information exchange may be made available with transmission/reception of radio waves instead of the communication cable 20. The communication cable 20 of FIG. 1 or 24 is intended to depict that the server 14, the base station 12 (116), and the printer 16 (116) are enabled to exchange information through the communication cable 20 and does not depict a connection configuration of the communication cable 20 in a limited manner.

Although the base station 12 and the printer 16 are separately provided and the mobile station 10 and the computer 18 are separately provided in the above embodiments while, in the above another embodiment, the computer 118 has the functions of the computer 18 and the functions of the mobile station 10 of the above embodiments and the printer 116 has the functions of the printer 16 and the functions of the base station 12 of the above embodiments, such an aspect is not a limitation. For example, some aspects can be implemented in such way that the base station 12 and the printer 16 are separately provided while the computer 118 is used that has the functions of the computer 18 and the functions of the mobile station 10 of the above embodiments or that the mobile station 10 and the computer 18 are separately provided while the printer 116 is used that has the functions of the printer 16 and the functions of the base station 12 of the above embodiments. Some of the plurality of printers making up the printer selection system 9 may be the printers 116 having the functions of the printer 16 and the functions of the base station 12 of the above embodiments and other printers may be the printers 16 as long as the total number of the printers 116 and the base stations 12 exceeds the number of base stations necessary for positioning the mobile station 10 in such a case.

Although the passageway information database portion 58 and the arrangement information database portion 66 are separately provided in the embodiments, these portions may be provided as a common database if common information is stored in these portions.

In the embodiments, the display control portion 64 generates display contents for displaying information of a printer set by the printer setting portion 62 as the printer performing the output corresponding to the output request on the displaying device 92 of the computer 18 and the display contents are displayed on the displaying device 92 of the computer 18. However, even if the display control portion 64 is not included, since the printer selection system 9 sets the printer nearest to the computer 18 making an output request as the printer that performs the output corresponding to the output request, a certain degree of effect is achievable. The display control portion 64 is not an essential requirement for the printer selection system 9.

Although the mobile station 10 transmits the radio wave for the positioning (SB5) after receiving a command for radio wave transmission transmitted from the base station 12 (affirmative at SB4) in the embodiments, such an aspect is not a limitation. The mobile station 10 may be set to transmit the radio wave for the positioning at predetermined intervals and only when the positioning server 14A gives a command for executing the positioning, the base station 12 may receive the radio wave for the positioning transmitted from the mobile station 10.

Only the embodiments have been described and the present invention can be implemented in variously modified and improved aspects based on the knowledge of those who skilled in the art.

What is claimed is:

1. A printer selection system that responds to an output request from a computer to select a printer for performing output responsive to the output request from a plurality of printers connected through a communication network to the computer, comprising:
a mobile station moved along with the computer;
a plurality of base stations fixedly disposed at known positions; and
a server connected to the computer in a manner that enables data communication, the server including
a positioning portion that determines a position of the mobile station as a position of the computer based on a reception result of a radio wave for position detection transmitted from one of the plurality of the base stations and the mobile station and received by the other,
a printer position database portion storing information about positions of the plurality of the printers stored therein in advance,
a distance determining portion that determines a distance between a position of each of the plurality of the printers and the position of the computer, and
a printer setting portion that sets a printer having the shortest distance as a printer that performs the output from the computer based on the distances between the position of each of the plurality of the printers and the position of the computer that are determined by the distance determining portion.

2. A printer selection system that responds to an output request from a computer having a radio communication function to select a printer for performing output responsive to the output request from a plurality of printers having a radio communication function and connected using the radio communication function to the computer in a manner that enables data communication, comprising:
a server connected to the computer in a manner that enables data communication, the server including
a positioning portion that determines a position of the computer based on a reception result of a radio wave for position detection transmitted from one of the plurality of the printers and the computer and received by the other,
a printer position database portion storing information about positions of the plurality of the printers stored therein in advance,
a distance determining portion that determines a distance between a position of each of the plurality of the printers and the position of the computer, and
a printer setting portion that sets a printer having the shortest distance as a printer that performs the output from the computer based on the distances determined by the distance determining portion between a position of each of the plurality of the printers and the position of the computer determined by the positioning portion.

3. The printer selection system according to claim 1, wherein
the distance determining portion determines a distance between a position of each of the plurality of the printers and a position of the computer as a linear distance therebetween.

4. The printer selection system according to claim 1, comprising a passageway information database portion storing information about a position of a passageway stored thereon in advance, wherein
the distance determining portion determines the distance between the position of each of the plurality of the printers and the position of the computer along shortest route among routes on the passageway based on the passageway information stored in the passageway information database portion.

5. The printer selection system of claim 1, further comprising a printer attribute database portion storing information about attributes of the plurality of the printers, wherein
the printer setting portion extracts one or a plurality of printers satisfying an output request from the computer based on the information stored in the printer attribute information database portion and sets a printer having the shortest distance from the computer calculated by the distance determining portion as a printer that performs the output from the computer among the extracted one or a plurality of printers.

6. The printer selection system of claim 1, further comprising a display control portion that controls a displaying device included in the computer to display information about a position of a printer set by the printer setting portion.

7. The printer selection system of claim 6, further comprising an arrangement information database portion storing positional information of arranged objects stored therein in advance, wherein
the display control portion controls the displaying device to display positions of a printer set by the printer setting portion and the computer positioned by the positioning portion on an arrangement view generated based on the positional information of the arranged objects stored in the arrangement information database portion.

8. A computer used in the printer selection system according to claim 1,
wherein the computer has functions of the mobile station.

9. A printer used in the printer selection system according to claim 1,
wherein the printer has functions of the base stations.

10. The printer selection system according to claim 2, wherein
the distance determining portion determines a distance between a position of each of the plurality of the printers and a position of the computer as a linear distance therebetween.

11. The printer selection system according to claim 2, comprising a passageway information database portion storing information about a position of a passageway stored thereon in advance, wherein
the distance determining portion determines the distance between the position of each of the plurality of the printers and the position of the computer along shortest route among routes on the passageway based on the passageway information stored in the passageway information database portion.

12. The printer selection system according to claim 2, comprising a printer attribute database portion having information about attributes of the plurality of the printers, wherein
the printer setting portion extracts printers satisfying an output request from the computer based on the information stored in the printer attribute information database portion and sets a printer having the shortest distance from the computer calculated by the distance determining portion as a printer that performs the output from the computer among the extracted printers.

13. The printer selection system according to claim 2, further comprising a display control portion that controls a displaying device included in the computer to display information about a position of a printer set by the printer setting portion.

14. The printer selection system according to claim 13, further comprising an arrangement information database portion storing positional information of arranged objects stored therein in advance, wherein
the display control portion controls the displaying device to display positions of a printer set by the printer setting portion and the computer positioned by the positioning portion on an arrangement view generated based on the positional information of the arranged objects stored in the arrangement information database portion.

15. A computer used in the printer selection system according to claim 2,
wherein the computer has functions of the mobile station.

16. A printer used in the printer selection system according to claim 2,
wherein the printer has functions of the base stations.
